(19) United States
(12) Patent Application Publication
(10) Pub. No.: US 2018/0043641 A1
(43) Pub. Date: Feb. 15, 2018

(54) 3D ARCHITECTURAL FRP SHELLS AND PANELS

(71) Applicant: Mohammad Reza Ehsani, Tucson, AZ (US)

(72) Inventor: Mohammad Reza Ehsani, Tucson, AZ (US)

(21) Appl. No.: 15/237,582

(22) Filed: Aug. 15, 2016

(51) Int. Cl. B29C 70/44; B29C 70/02; B29C 70/24

(52) U.S. Cl. CPC B29C 70/44; B29C 70/24; B29C 70/028; B29K 2105/12

(57) ABSTRACT

Methods and articles of manufacture are disclosed for Architectural shells and/or Panels (AP) of desired shapes, sizes, and curvatures that can be manufactured onsite or offsite. The disclosed Architectural shells and Panels, which use resin-impregnated fabrics in combination with spacer sheets, are easy to manufacture, inexpensive, fast to produce, and can easily be repaired, reinforced and refurbished.

### CROSS-REFERENCE(S) TO RELATED APPLICATION(S)

This non-provisional application is related to U.S. provisional patent applications No. 62/218,888 filed on 15 Sep. 2015, the disclosure of which is hereby expressly incorporated by reference in its entirety, and the benefit of the priority date of which is hereby claimed under 35 U.S.C. §119(e).

### TECHNICAL FIELD

This invention relates generally to the field of construction. More specifically, this application relates to awnings, roof panels and wall panels, etc. that are used to enhance the appearance and functionality of structures and buildings.

### BRIEF DESCRIPTION OF THE DRAWINGS

The drawings, when considered in connection with the following description, are presented for the purpose of facilitating an understanding of the subject matter sought to be protected.

FIG. 1 shows an example of a formwork/jig for fabrication of an architectural panel according to the disclosed methods.

FIG. 2 shows an example 3D-fabric to be used by itself or as a spacer-sheet in the formation of architectural panels;

FIG. 3 shows an example fabricated awning which has been formed over the formwork of FIG. 1, using only a 3D-fabric; and

FIG. 4 shows another example fabricated awning which has been formed over the formwork of FIG. 1, using a spacer-sheet laminated between two resin-saturated fabrics.

### DETAILED DESCRIPTION

While the present disclosure is described with reference to several illustrative embodiments described herein, it should be clear that the present disclosure should not be limited to such embodiments. In addition, while the following description references using combinations of resin-saturated fabric and honeycomb sheets to create durable three dimensional surfaces, it will be appreciated that the disclosure may include fewer or more laminate sheets of the same or other kinds and materials to cover and/or sandwich spacer sheets and/or hollow structures of various kinds. Furthermore, while the following description references using adhesive between sheets of different layers, it will be appreciated that the disclosure may include other methods of securing adjacent sheets together.

Briefly described, architects and construction professionals often require lightweight structures to provide shade and protection from the environment such as rain, snow, wind, sun and the like. These may be in the form of an awning or roof structure; however, they may also be parts of vertical structures. Examples of such applications include walkways between buildings, bus or tram stops, park ramadas, waiting areas in front of a hotel, and the like. In other applications, the lightweight structure may be used as a sound barrier inside a room or theatre. In some of these applications the structure may be positioned overhead (as a false ceiling) or as vertical elements attached to or spaced near vertical walls in the room or theatre. In some other applications the APs may be used as noise barrier walls along freeways and roads; the light weight of such APs compared to conventional panels made with concrete provides significant safety in case a car crashes into the noise barrier APs.

While the disclosed methods, systems and apparatus are mainly to enhance the appearance of buildings, they can also be designed to improve the functionality of these structures as well. Such structures are subjected to loads induced by gravity, traffic, earthquakes, blast and explosion, strong winds, flow-induced forces from water and the like.

Throughout this specification these Architectural Panels (AP) are referred to by their acronym AP for singular and APs for plural. Alternatively, in design and construction of buildings, similar APs are used primarily as vertical or inclined panels positioned around the building at various heights. These APs may be, for example, attached to a building on the outside of each window to control the light and heat entering and/or exiting the building.

Architects often use APs as decorative elements to add to the aesthetics of the design and at times to convey an underlying theme or idea. Examples of this include the entire exterior façade of the Walt Disney Music Hall in Los Angeles, which is constructed with curved APs that are individually designed and constructed. The APs of the Walt Disney Music Hall include sophisticated geometrical surfaces that are very expensive to construct. The stainless steel APs in this case, for example, must be fabricated to precise measurements and welded or bolted together to create an illusion of a seamless or a single-piece AP. Such APs are noticeably heavy and the construction of the underlying frame, which itself is a massive and heavy structure, is a major undertaking. There is a need for an easily manufactured, lightweight structure that can be formed into various curved geometries for use as APs.

Several embodiments of the new construction technique are presented here. Those skilled in the art realize that these are only some of the examples of this technique and various alterations are possible without deviating from the spirit of the proposed methods.

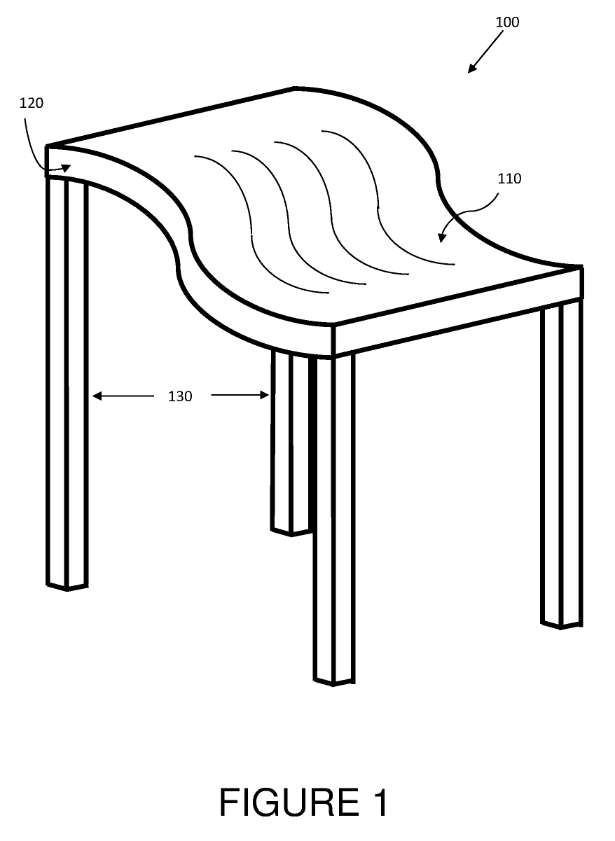

In some embodiments, a formwork or a jig may be first constructed. FIG. 1 shows an example of a formwork/jig 100 for fabrication of an AP. The example formwork 100 includes the main formwork body 120, which is mounted on four legs 130. In FIG. 1, surface 110 of the formwork body 120 has the same shape as the desired awning that will be formed and fabricated over this formwork. Formworks may be constructed to have substantially the same or similar shapes and surface geometries as the desired finished APs. Throughout this document the term formwork, mold, or jig is used interchangeably to represent a variety of structures that can be assembled to assist with the construction of the APs. One type of formwork can be made of flexible thin wood or plastic sheet panels that are connected together and held in a shape representing the shape of the desired AP. In some embodiments the formwork may be constructed of moldable clay or similar products used by artists and sculptors to create or mold the finished surface more precisely. These surfaces may be coated with a release agent or Mylar sheets and the like to allow easy removal of the AP and/or multiple re-use of the formwork. It should be noted that it is not required to make a special jig for constructing an AP. Existing objects and structures may be used as jigs if desired. For example the outside surface of an automobile may be used as a formwork to create an AP in the shape of an automobile or stairs of a building may serve as a mold to fabricate an awning in the form of stairs. In some embodiments the AP may be constructed over a structure and be left in place for any desired reason.

In another embodiment the formwork may include an inflatable bladder whose geometry is defined by its shape and by the amount of air pressure used to inflate the bladder or by other design factors. A large bladder, for example, can be used to form a semi-spherical dome shape.

In one embodiment one or more layers of resin-saturated fabric are placed on the formwork. Before this fabric cures, or in some embodiments after the resin is cured, one or more layers of a spacer sheet, such as honeycomb sheets, are placed on the fabric. In embodiments in which the fabric is cured before the placement of the spacer sheet, additional adhesive may be used to attach the fabric layers together and/or to the spacer sheet. Honeycomb sheets, and in general the spacer sheets, may be scored to allow them to deform and mold to the shape of the formwork. Subsequently, one or more layers of resin-saturated fabric are placed on top of the spacer sheet(s) to sandwich the spacer sheet(s) between the layers of resin-saturated fabric. In some embodiments the entire system is allowed to cure together to create a very light-weight but strong Fiber Reinforced Polymer (FRP) structure. Those skilled in the art realize that applying some pressure or vacuum to the uncured system or parts of the system will help maintain the deformed shape of the AP. The term Fiber Reinforced Polymer (FRP) refers to fabrics made of, for example, glass, carbon, Kevlar, Basalt, and woven metal wires saturated with a resin such as epoxy, vinyl ester, polyester, polyurethane, and the like.

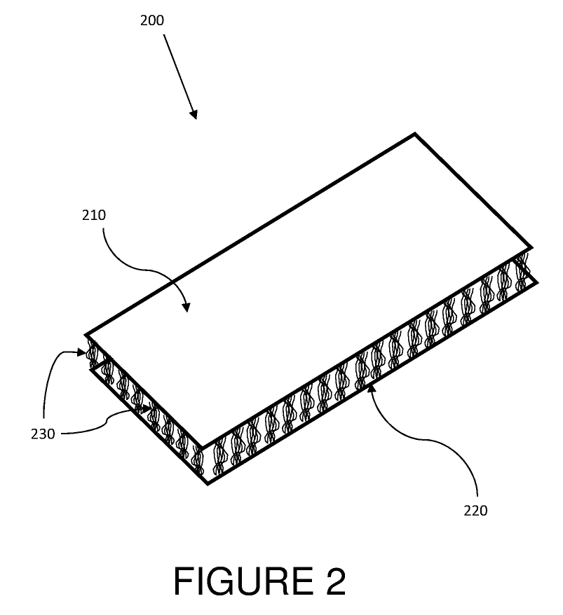

In various embodiments, a layer of 3D fabric is impregnated or saturated with a resin and laid over the formwork. A 3D fabric is a special type of fabric made, for example, with glass, carbon, or Kevlar reinforcing fibers. The fabric 200, for example as illustrated in FIG. 2, is woven as two fabric layers 210 and 220 that are connected with short fibers 230 of glass, carbon or Kevlar fibers. During application of 3D fabrics, both layers 210 and 220 of the fabric can be saturated with a resin such as epoxy, polyester or vinyl ester at the same time. During the curing process, the short fibers 230 will rise causing further separation between the two layers 210 and 220 of the fabric to form a rigid 3D structure. This process results in a cured three-dimensional structure with a certain thickness and stiffness that is more than the thickness and stiffness of the 3D fabric 200 before the application of the resin.

The curing of the resin can be achieved in ambient conditions or it can be expedited by using resins whose cure time is accelerated by heat, UV, microwave, electrical current, etc. In various embodiment extra layers of resin-saturated fabric may be added to one or both sides of the 3D fabric, before or after the 3D fabric is cured. It should be noted that extra layers of resin-saturated fabric may always be added to any finished AP, even after years of use, for repair, reinforcement or refurbish.

The resulting thickness, after the application of resin, is determined by the length of the short fibers 230 connecting the two fabric layers 210 and 220 together. Typical fiber lengths are 2 to 30 mm. I-beams are commonly used in construction where the two flanges are separated by a web. The short fibers in a 3D fabric work similar to the web of an I-beam. The result is a structure that is much stiffer and stronger than if the two layers of fabric were directly bonded together without any separation between them. 3D fabrics are available through a small number of manufacturers worldwide including Jushi Beihai Fiberglass Co., LTD in China. Additionally, the hollow space between the two faces of the 3D fabric may be filled with various filler materials such as foam, rubber, resin, concrete, rebars and the like.

A significant advantage of the proposed technique is its ease of construction. Once a formwork has been provided, the APs can be easily manufactured on or very close to the construction site, where the APs are intended to be installed. Because APs can be bulky, their transportation can add significant cost to any project and cause damage to the APs. This is particularly true for the currently used APs that are both bulky and heavy. In contrast, the disclosed APs are very light and can be easily manufactured onsite; eliminating nearly all transportation costs and difficulties.

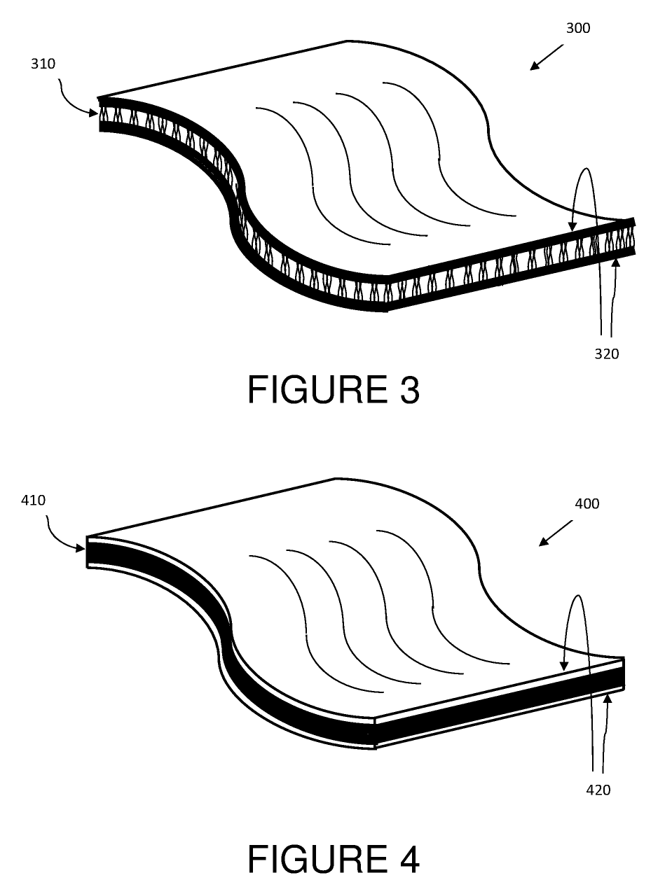

In some embodiments multiple layers of 3D fabric can be placed adjacent or on top of one another to create a desired AP of a given size, thickness, shape and strength. Furthermore, extra layers of resin-saturated fabric may also be added to one or both sides of the 3D fabric layers, before or after the 3D fabrics are cured. In yet other embodiments, multiple layers of 3D fabrics, spacer sheets and/or resin-saturated fabrics may be laminated together in any desired order to form the AP. The cured AP is removed from the formwork and its edges may be trimmed and cut to any configuration. FIG. 3 shows an example fabricated awning 300 which has been formed over the formwork 100 of FIG. 1, using a single-layer 3D-fabric that includes two fabric layers 320 and short connecting fibers 310.

If desired, holes or hardware to receive bolts and fasteners can also be incorporated in the APs. These fittings may be used to support the APs from hangers or on top of columns or to connect several APs together to create a larger AP. In some embodiments, reinforcement elements, such as rebars, concrete or other fillers, may be placed in the hollow spaces available within the spacer sheet to especially reinforce the compressive and/or bending strength of the AP in any desired direction. In other embodiments the reinforcement elements may be merely placed between the laminated layers.

Different 3D fabrics are available to achieve various thicknesses upon curing. For example, a 5 mm thick 3D may be appropriate for smaller (shorter span) APs. A 10 mm thick 3D is stronger and more suitable for a larger AP. The thickness of the 3D fabric may affect the radius of bend or the curvature that it can be bent to during the forming of an AP. In some cases, a thick 3D fabric will crimple when forced to bend around a sharp corner, e.g. 90 degrees. Such problems can be minimized by using the appropriate thickness 3D fabric or by repairing and strengthening the bent region with additional FRP sheets after the AP has been manufactured or before it is fully cured. Another option is to overlay multiple thinner 3D fabrics instead of a thick 3D fabric.

In some embodiments the exterior surface of the AP is coated with architectural finishes such as paints, colored sand, metallic sheets (e.g. stainless steel, copper, etc.), fire proofing materials and the like. In some embodiments the surface(s) of the AP may be coated with photovoltaic panels that can generate electricity. In some embodiments the voided space between the two faces of the 3D fabric can be filled with foam, concrete, grout, resin and the like to give it more rigidity and strength. However, these filler materials add to the weight of the AP; therefore, it may be advisable to keep them to a minimum.

In various embodiments, reinforcing elements such as FRP rods or fabric, metallic rods, etc. can be inserted (or threaded) in the space between the two sheets of the 3D fabric. In some embodiments this can be done in combination with the use of filler materials described above. Depending on the engineering design of the APs and the use of the reinforcing elements and/or the filler materials, in some embodiments the APs may be structurally self-supporting while in other embodiments the APs may need to be supported by other structures and frames. In yet various other embodiments, in addition to the aesthetics and other desired functions, the APs may be employed to add to the structural strength of another structure.

FIG. 4 shows another example fabricated awning 400 that has been formed over the formwork 100 of FIG. 1, using a spacer-sheet 410 laminated between two resin-saturated fabrics 420. In some embodiments the spacer-sheet 410 may itself be a 3D fabric. In other embodiments one or more layers of spacer-sheets 410 and/or one or more layers of resin-saturated fabrics 420 are placed on the formwork 100 in any desired combinations and permutations. The APs manufactured according to the enclosed methods and techniques can be supported in a variety of ways on columns or along one or more edges.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Additionally, the phrase “A and/or B” also will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method of constructing an architectural shell or panel onsite or offsite, the method comprising:
providing a formwork with substantially same or similar surface geometry as the desired architectural panel;
placing at least one resin-impregnated 3D fabric over the formwork to cover a desired area of the formwork;
allowing the resin-impregnated 3D fabric to at least partially cure; and
removing the at least partially cured 3D fabric from the formwork.

2. The method of claim 1, wherein the formwork is either an existing object, a rigid structure, or is an inflatable bladder or a combination thereof.

3. The method of claim 1, further comprising an additional step of attaching reinforcing elements to an exterior surface of and/or placing reinforcing elements and/or a filler material within an inner space of the architectural panel.

4. The method of claim 3, wherein the reinforcing elements are metallic or non-metallic.

5. The method of claim 1, further including an additional step of applying finish coating to an exterior surface of the 3D architectural panel.

6. The method of claim 1, wherein the 3D fabric is an expanding or a non-expanding spacer sheet.

7. The method of claim 1, further including placing at least one resin-impregnated fabric over the formwork before placing the resin-impregnated 3D fabric or placing at least one resin-impregnated fabric over the resin-impregnated 3D fabric after the resin-impregnated 3D fabric is placed over the formwork, or both.

8. The method of claim 3, wherein the filler material is foam, rubber, or concrete.

9. A method of manufacturing an architectural shell or panel, the method comprising:
providing a jig with substantially same or similar surface geometry as the desired architectural panel;
placing at least one resin-impregnated fabric over at least a part of the jig surface;
placing at least one spacer sheet over at least a part of the jig surface, wherein the resin-impregnated fabric and the spacer sheet have at least some overlap;
allowing the resin to at least partially cure; and
removing the partially cured architectural panel assembly from the jig.

10. The method of claim 9, further including application of pressure or vacuum to the assembly while being cured.

11. The method of claim 9, wherein the jig is either an existing object, a rigid structure, or is an inflatable bladder or a combination thereof.

12. The method of claim 9, further including an additional step of attaching reinforcing elements to an exterior surface of and/or placing reinforcing elements and/or a filler material within an inner space of the architectural panel.

13. The method of claim 9, wherein the spacer sheet is a honeycomb sheet.

14. The method of claim 9, wherein any desired combination or permutation of resin-impregnated fabric layers and resin-impregnated spacer-sheet layers is formed.

15. The method of claim 12, wherein the reinforcing materials are metallic or no-metallic.

16. The method of claim 9, further including an additional step of applying finish coatings to an exterior surface of the assembly.

17. The method of claim 16, wherein the exterior coating includes paint, fire-proofing materials and/or decorative particles.

18. The method of claim 12 where the filler material is foam, rubber, or concrete.

19. The method of claim 9 wherein a first resin-impregnated fabric is laid over at least a part of the jig surface and one spacer sheet is laid over at least a part of the first resin-impregnated fabric layer and a second resin-impregnated fabric is laid over at least a part of the spacer sheet layer.

20. The method of claim 9, wherein the spacer sheet is an expandable 3D fabric or any hollow-structure sheet of material.
